(19) United States
(12) Patent Application Publication
(10) Pub. No.: US 2017/0010519 A1
(43) Pub. Date: Jan. 12, 2017

(54) Protective Case for Electronic Camera/Camcorders for Air, Land and Underwater Use Employing Sun Blocking Shade of Display Screen

(71) Applicant: Larry Tang, East Brunswick, NJ (US)

(72) Inventor: Larry Tang, East Brunswick, NJ (US)

(21) Appl. No.: 15/202,638

(22) Filed: Jul. 6, 2016

Related U.S. Application Data
(60) Provisional application No. 62/188,815, filed on Jul. 6, 2015.

(51) Int. Cl. G03B 11/04; H04N 5/225; G03B 17/08

(52) U.S. Cl. CPC G03B 11/046; G03B 17/08; H04N 5/2252

(57) ABSTRACT

A protective case for an electronic camera/camcorder including a sunblock shade, opaque and impervious to light, to close off the display screen of the camera/camcorder when viewed through a transparent back surface of the case.

### CROSS-REFERENCE TO RELATED APPLICATIONS

A Provisional Patent Application covering the invention described herein was filed on Jul. 6, 2015, and assigned Ser. No. 62/188,815.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

### Field of the Invention

This invention relates to electric camcorders, in general, and to those employing protective cases for air, land and underwater use, in particular.

### Description of the Related Art

As has been described, if people wanted footage of themselves engaged in physical activities, until fairly recently, they needed another person to hold and operate an electronic camera for them. Furthermore, the camera operator needed to be skilled in order to obtain compelling content. Additionally, capturing high-quality content often required expensive, fragile and cumbersome camera equipment that was not accessible to everyone. Accordingly, it was not often practical for people to document their experiences during their lives' most enjoyable moments.

In order to accommodate photography during such physical activities as skating, skiing, hiking, biking, mountain climbing and sky-diving, for example, camera manufacturers have recently come to develop, manufacture and market high-definition digital video electronic camera/camcorders, often used in these action video photographic instances. Compact, lightweight, rugged and simple to operate, camcorders of this sort have been made available to capture still photos or video through a wide-angle lens, with accessories to mount to a helmet, to a bumper or to a windshield of a vehicle. Various wearable or mountable manners have also been developed to facilitate self-capture experiences different from those previously attainable with traditional cameras and smartphones.

Recognizing that the use of these camera/camcorders would also offer unique photographic perspectives in such activities as surfing, snorkeling, spear fishing, kayaking, white water rafting, and scuba-diving, protective cases claiming a waterproof capability have been proposed to enclose these video systems for use in such environmental activities—or even just for wet-weather photographing in general.

As will be appreciated, such digital video electronic camera/camcorders, whether designed for air and land—and for underwater use in accordance with further developments—are not inexpensive. Costing several hundreds of dollars, and even more, their availability to wide sectors of the populous becomes increasingly limited as the sophistication of the digital systems become greater. But, as it has been recognized that shoes are rentable at bowling alleys, that skates are rentable at ice and roller rinks, that skis and boots are rentable at the slopes and that clubs are rentable at golf course pro shops, so too it is hoped that these protective waterproof cases and digital video electronic camera/camcorders will also become available for daily and weekly rentals—and not only for air and land use as in skating, skiing, hiking, biking, mountain climbing and sky-diving, but also in such wet-weather and underwater activities as surfing, snorkeling, spear fishing, kayaking, white water rafting, scuba diving and ski jumping.

Appreciating that the general rough nature of these activities might very well lead to possible damage of the electronic camera/camcorders, several of them have been manufactured for inclusion within protective cases. Whether the electronic camera/camcorders be within the protective cases for photographing air, land, wet-weather or underwater activities, however, investigation and analysis led to the realization that it could be beneficial to additionally allow for their rentals rather than their sales, and in a manner where relatively simple repairs could be made at a rental distribution center—and, more particularly, repairs of a most common type of damage in allowing them to be used once again within matters of a few minutes after their return at the drop off point.

To such end, my concurrently filed Application (Non-Provisional Serial No. ______ based on Provisional Application Ser. No. 62/188,789) describes a protective waterproof case for electronic camera/camcorders for air, land and underwater use that becomes effectively repairable through the employment of dual lens covers and lens cover frames, a disposable lens cover of lesser quality and durability emplaced atop a more expensive lens cover, to be easily removed if scratched or otherwise damaged—and then replaced with a provided substitute. As there set out, a greater detail of repair work would otherwise be required to remove and replace the lens cover and lens cover frame that were installed as part of an initial protective case manufacture and placement for ale, they being of higher quality and of greater cost.

In such development, however, it was additionally realized that in both daytime air and land recording, sunlight often shining on the back cover of the case made it difficult to get a clear viewing on the digital video electronic camera/camcorder screen of the physical activity that had been recorded, either just then, or earlier.

### OBJECT OF THE INVENTION

Appreciating the annoyance of eventually determining a dissatisfaction with the activity recorded because of the sunlight, it made it exceedingly difficult, if at all possible, to try to replicate the preciseness or effects of the activity a second time. Thus, it is an objective of the present invention to block the rays of the sun from the screen viewed through the transparent back cover of the case at the start, to begin with.

### SUMMARY OF THE INVENTION

As will become clear from the following description, the case of the invention for electronic camera/camcorders for air and land use includes an appropriate sun blocking shade which quiescently overlaps the transparent back cover of the case, but which can be lifted away to shade the screen from sunlight in trying to view the activity that had been recorded. As will be appreciated by those skilled in the art, such feature of sunblock shading would be desirable for any case of this nature employable for air and land use protected or not; and, further for one allowing underwater use as well, as noted in my concurrently filed Application. For such reason, the following description should be read in light of such understanding.

### BRIEF DESCRIPTION OF THE DRAWINGS

These and other features of the invention will be more clearly understood from a consideration of the following description, taken in connection with the accompanying Drawings in which:

FIGS. 1a-1g are 7 views of a protective case for a digital video electronic camera/camcorder with a clear lens cover and lens cover frame as described in my concurrently filed Application (Non-Provisional Ser. No. ______ based on Provisional Serial No. 62/188,779)—with FIG. 1a being a front elevation view of the protective waterproof case, FIG. 1b being a top plan view thereof, FIG. 1c being a bottom plan view thereof, FIG. 1d being a right side elevation view, FIG. 1e being a left side elevation view, FIG. 1f being a rear elevation view, and FIG. 1g being a rear perspective view of the protective waterproof case;

FIGS. 2a-2d and 3a-3d respectively illustrate various of single and dual lens covers and lens cover frames helpful in the operation of the protective waterproof case of FIG. 1.

FIGS. 4a-4g are 7 views respectively comparable to those of FIGS. 1a-1g for a protective waterproof case but with the dual lens covers and lens cover frames of my concurrently filed Non-Provisional Serial No. ______ Application based on the Ser. No. 62/188,789 Provisional Application;

FIGS. 5a-5g are 7 views respectively comparable to those of FIGS. 4a-4g but with the sunblocking shade of the present invention; and

FIGS. 6a-6d are helpful in an understanding of the operation of the sunblocking shade of this present invention.

### DETAILED DESCRIPTION OF THE INVENTION

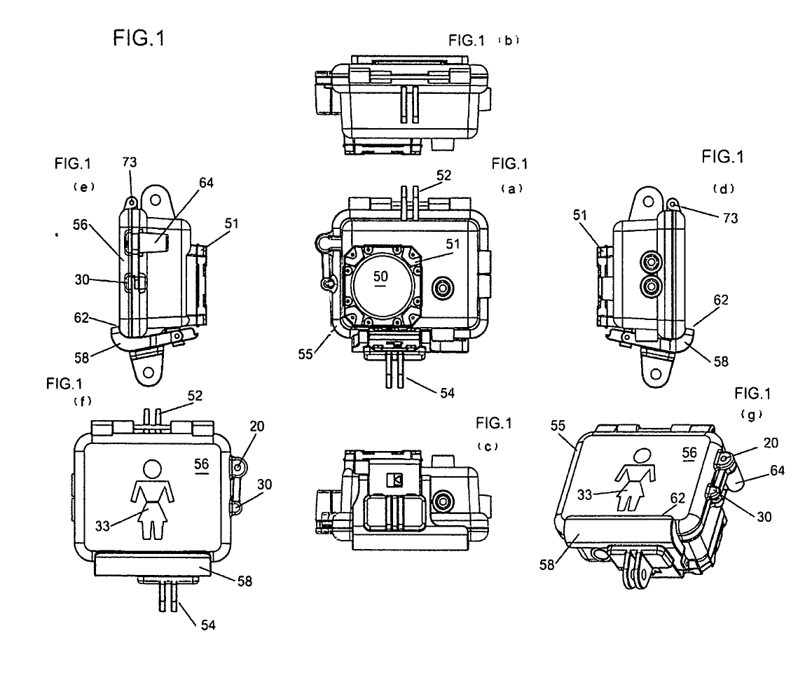

In accordance with my concurrently filed Non-Provisional Application Ser. No. ______ based on my Provisional Application Serial No. 62/188,779, the general difference between an air and land use protective waterproof case and one intended additionally for underwater and wet weather usage is the inclusion in the latter of an audio port to allow sound from an outside environment to reach the built-in microphone incorporated in the digital video electronic camera/camcorder. With this understanding, the 7 views of FIG. 1 herein together illustrate a protective waterproof case for these digital video cameras for air, land and underwater use. In these views, reference numerals 50 and 51 respectively identify a clear lens cover and a surrounding lens cover frame for the case 55, references numerals 52 and 54 represent pillar receptors to couple to various mounts and accessories for the case and for the digital video electronic camera/camcorder enclosed within, and reference numeral 56 represents a transparent back cover. Reference numeral 58 represents the latch member to lock and hold the back cover 56 closed, with its lip 62 bendable outward to allow the back cover 56 to be opened and closed. Reference numeral 64 represents the cup of an audio port for passing sound into the compartment which encloses the electronic camera/camcorder.

In accordance with that Non-Provisional application Ser. No. ______ based on the Ser. No. 62/188,779 Provisional Application, the audio port may be closed by inserting the plug of a sealing device into the cup for underwater use where sound input is not generally relevant in a recording, or opened by withdrawing the plug to allow desired sound pressure waves to penetrate for land and air use; in a second version described therein, the audio port cup itself included a waterproof acoustic membrane within, and spanned across the cup to allow the passage of sound to the electronic camera/camcorder microphone input (but not water) in the event the sealing device plug was forgotten to be inserted in advance of a water environment type usage.

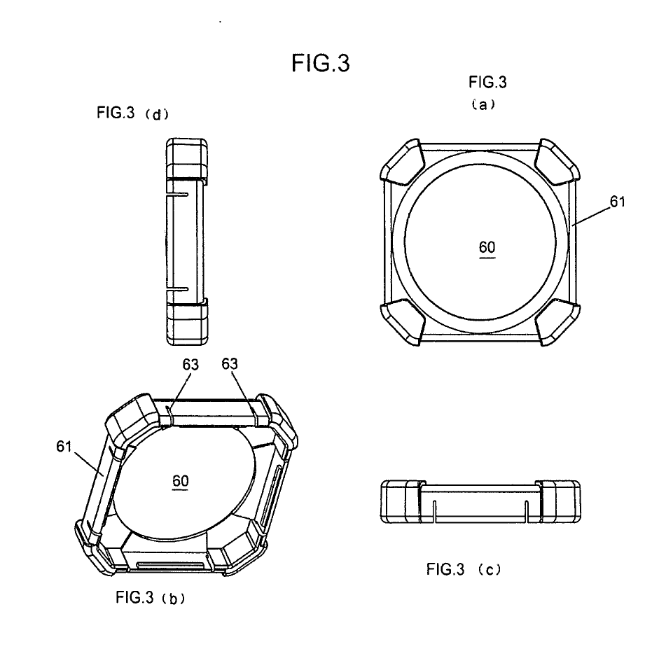

In accordance with the teachings of my concurrently filed Non-Provisional application Ser. No. ______ based on the Ser. No. 62/188,789 Provisional Application, a second clear lens cover 60 and a second surrounding lens cover frame 61 are employed, with the second clear lens cover 60 intended to be of a disposable material and/or of a lesser durability characteristic than that associated with the lens cover 50 and surrounding lens cover frame 51. Such second lens cover 60 and such second surrounding frame 61 are illustrated in the front elevation view of FIG. 3a, and with a plurality of clip or like fastener receptors 63 shown in the rear perspective view of FIG. 3b, the top plan view of FIG. 3c and the left side view of FIG. 3d—a right side view being a mirror image.

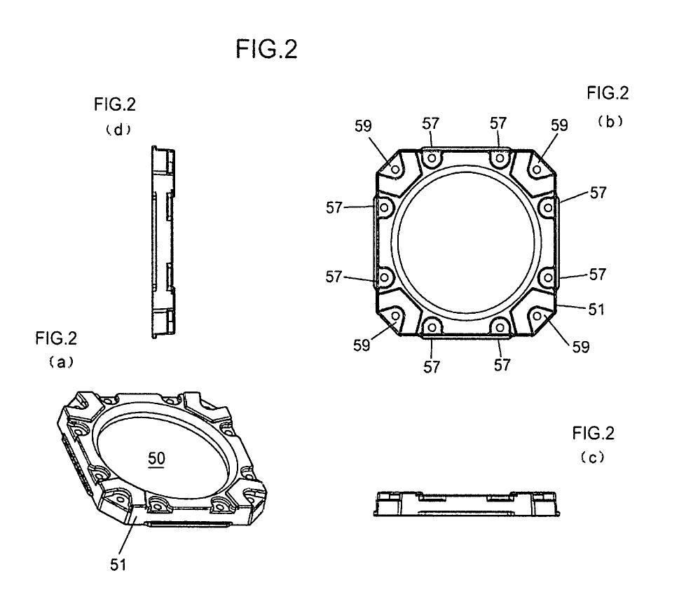

The clear lens cover 50 and the surrounding lens cover frame 51, on the other hand, are shown in the front perspective view of FIG. 2a, in which FIG. 2b is a front elevation view, FIG. 2c is a top plan view and FIG. 2d is a left side view, a right side view being a mirror image. To protect the more expensive clear lens cover 50, the second lens cover 60 and the second surrounding frame 61 of FIG. 3 can then be clipped to or snapped over the frame 51 and held in position, or incorporated as a slide that can be secured in position atop the clear lens cover 50 and frame 51. As therein described, the clear lens cover 50 is secured within the lens cover frame 51 by means of fasteners 57, with the frame 51 then being secured to the front surface of the protective case by prong fasteners 59. When damage to the cover-up second lens cover 60 follows, the second lens cover frame 61 merely has to be unclipped, unsnapped or slid upwardly, and replaced in a matter of seconds, for the continued taking of stills or videos in the photographic environment of concern—thereby protecting the more costly clear lens cover 50. Such arrangement is believed to be particularly useful where the user of the digital video electronic camera/camcorder and protective case utilizes the equipment on a daily or weekly rental basis, and is generally not being as careful with the video system as would be a purchaser spending hundreds of dollars on the video system to begin with. With that invention, a service person at a rental distribution station could just use a screwdriver, for example, to pry off the second lens cover frame 61 and discard it with its disposable lens cover 60 if necessary and replacing them for a subsequent use.

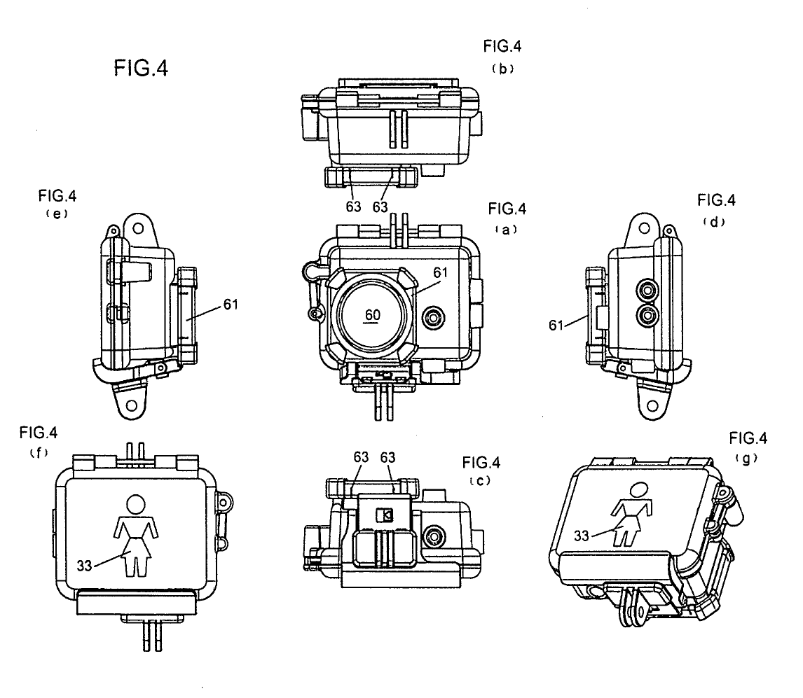

FIGS. 4a-4g essentially repeat the views of FIGS. 1a-1g except as to replace the single clear lens cover and surrounding lens cover frame with the dual lens and frame arrangement of FIGS. 3a-3g.

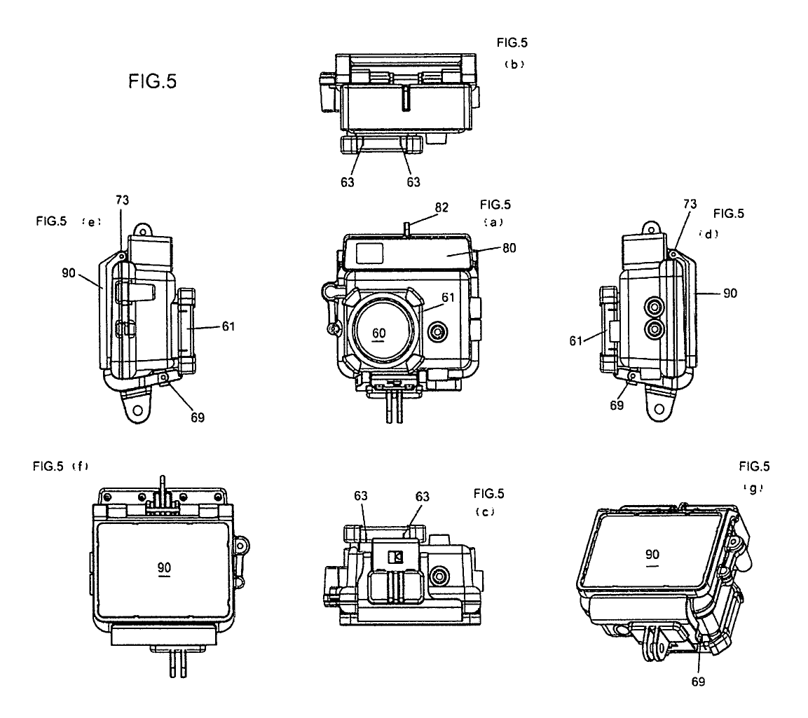

In a third co-pending Non-Provisional Application of mine (Serial No. ______, based on Provisional application Ser. No. 62/188,800), the protective waterproof case was modified to include a light source for use in low light level illuminations, by employing an adaptor to secure to the pillar receptors serving as a mount for accessories to the protective case. Such On-Off light source is shown in the 7 views of FIG. 5 herein by the reference numeral 80, with the adaptor shown as 82. The other components of FIG. 5 views are indicated by the reference numerals employed in the views of FIGS. 1 and 4.

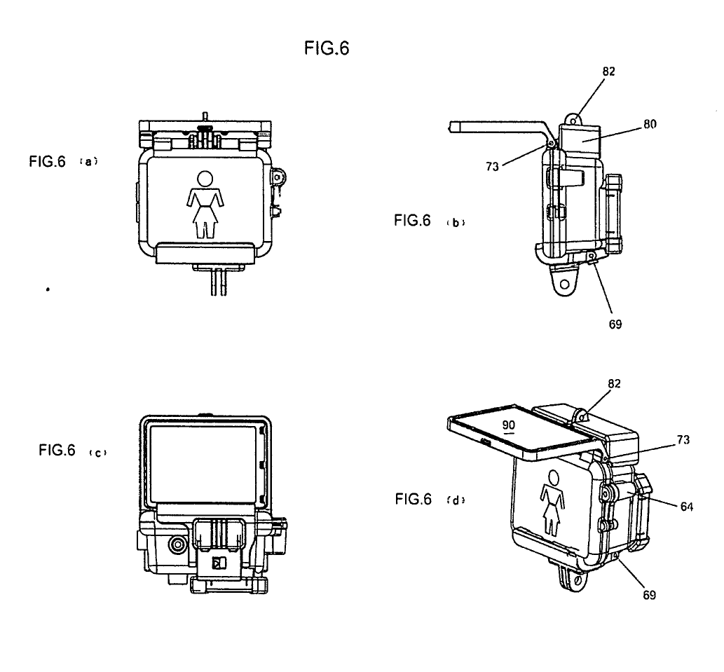

In accordance with the present invention, the protection carrier case further employs a sunblock shade, opaque and impervious to light, identified as 90 in the right and left side views of FIGS. 5d and 5e—with each of the views showing the sunblock shade 90 rotated “closed” about a hinge 73 in its quiescent state (a comparable hinge about which the back cover 56 can rotate, as in FIGS. 1d and 1e). Referring more particularly to FIG. 6, and understanding that FIG. 6a represents a rear elevation view of the protective case with the sunblock shade 90 rotated upwardly, that FIG. 6b represents a left side elevation view with the shade in its upward position, and that FIG. 6c represents a top plan side view with the shade “up”, the sunblock shade 90 is rotatable outwardly and upwardly along the hinge 73 as shown in the rear perspective view of FIG. 6d—from the vertical to the horizontal. The cup for the audio port is shown at 64, the On-Off light source 80 is shown in FIGS. 6b and 6d and the adaptor for connecting a lanyard to the protective case to carry it about a user's neck in front of his/her body is shown at 82. The logo on the digital video camera screen continues to be shown at 33 in replicating the views of FIGS. 1 and 4. A second hinge about which the latch member 58 rotates in locking the back cover 56 is shown at 69 in FIGS. 5d, 5e, and 5g, and in FIGS. 6b and 6d.

In one embodiment of the present invention, a top surface A of the sunblock shade 90 may be inscribed with instructions for the use of the controls of the protective case, with return address information if the case is lost or misplaced, or with any appropriate design or direction. Alternatively, the sunblock shade 90 may have an insert for the placement of any further information that might be desired.

As will be appreciated, however—and whether for just an air and land use protective case, or for a waterproof or wet weather case use as well, the blocking of sun rays from otherwise interfering with the electronic camera/camcorder display screen will be readily apparent.

While there have been described what is considered to be a preferred embodiment of the present invention, it will be readily appreciated by those skilled in the art that modifications can be made without departing from the scope of the teachings herein. For at least such reason, therefore, resort should be had to the appended claims for a true understanding of the invention.

I claim:

1. In combination with a digital video electronic camera/camcorder enclosed within a case, the apparatus comprising:
a transparent back surface of the case overlying a display screen of the camera/camcorder; and
an opaque shade operable to adjustably close off and open said screen for viewing by a user thereof through said back surface.

2. The apparatus of claim 1 wherein said opaque shade is manually operable to adjustably close off and open said screen for viewing in accordance with conditions of ambient light shining on said transparent back surface of the case.

3. The apparatus of claim 2 wherein said opaque shade, when manually opened, is operable to block sunlight from falling onto the display screen on the digital video camera/camcorder.

4. The apparatus of claim 3 wherein said opaque shade is hinged to a back cover of the case in rotating upwardly from a vertical towards a horizontal position in blocking sunlight from falling onto the display screen of the protective case.

5. In a protective case enclosing a digital video electronic camera/camcorder, apparatus comprising:
a transparent back cover on said protective case for viewing a display screen of said video camera/camcorder;
a first hinge at a lower portion of said cover;
a second hinge at an upper portion of said cover;
a latch member rotatable upward about said first hinge for locking and unlocking said back cover in position for a viewing of said display screen; and
a sunshade rotatable upwardly about said second hinge for blocking sunlight from shining on said display screen through said back cover.

6. The apparatus of claim 5, also including means at a top surface of said back cover for connecting individual ones of mount couplings and/or accessory couplings to said protective case.

7. The apparatus of claim 5, also including means at a bottom surface of said back cover for connecting individual one of mount couplings and/or accessory couplings to said protective case.

8. The apparatus of claim 6, also including first means at a top surface of said cover for connecting individual ones of mount couplings and/or accessory couplings to said protective case, and second means at a bottom surface of said back cover for connecting individual ones of mounting couplings and/or accessory couplings to said protective case.
